(19) United States
(12) Patent Application Publication
(10) Pub. No.: US 2024/0159360 A1
(43) Pub. Date: May 16, 2024

(54) APPARATUS, SYSTEM AND METHOD FOR HEAT AND COLD RECOVERY ONBOARD A FLOATING STORAGE REGASIFICATION UNIT

(71) Applicant: Excelerate Energy Limited Partnership, The Woodlands, TX (US)

(72) Inventors: Trevor Earl Wilkinson, San Diego, CA (US); Pedro Francisco Pinilla, Montgomery, TX (US)

(73) Assignee: Excelerate Energy Limited Partnership, The Woodlands, TX (US)

(21) Appl. No.: 18/503,507

(22) Filed: Nov. 7, 2023

Related U.S. Application Data
(60) Provisional application No. 63/424,220, filed on Nov. 10, 2022.

(51) Int. Cl. F17C 9/04; B63J 2/14

(52) U.S. Cl. CPC F17C 9/04; B63J 2/14; B63J 2002/125

(57) ABSTRACT

An apparatus, system and method for heat and cold recovery onboard a floating storage regasification unit (FSRU). A heat recovery apparatus onboard a FSRU includes a LNG vaporizer, a heat transfer fluid configured to transfer heat of vaporization to LNG in the LNG vaporizer during active regasification mode and thereby obtain cold of LNG, a heat recovery fluid including a portion of the heat transfer fluid, wherein the heat recovery fluid is configured to employ the cold of LNG to completely cool FSRU machinery and an FSRU air conditioning unit during active regasification mode, and thereby the heat recovery fluid obtains machinery heat, and wherein the heat of vaporization includes the machinery heat and at least one additional heat source.

### CROSS REFERENCE TO RELATED APPLICATIONS

This application claims the benefit of U.S. Provisional Application No. 63/424,220 to Wilkinson et al., filed Nov. 10, 2022 and entitled “APPARATUS, SYSTEM AND METHOD FOR HEAT RECOVERY ONBOARD A FLOATING STORAGE REGASIFICATION UNIT,” which is hereby incorporated by reference for all purposes, except to the extent that the incorporated material is inconsistent with the express disclosure herein, in which case the language in this disclosure controls.

### BACKGROUND OF THE INVENTION

### 1. Field of the Invention

Embodiments of the invention described herein pertain to the field of floating storage regasification units (FSRUs). More particularly, but not by way of limitation, one or more embodiments of the invention enable an apparatus, system and method for heat and cold recovery onboard a FSRU.

### 2. Description of the Related Art

Over the past decade, a method of transporting natural gas onboard special cryogenic tanker ships has developed. Since liquefied natural gas (LNG) occupies only about 1/600th of the volume than does the same amount of natural gas in its gaseous state, natural gas carried by these tanker ships is liquefied for transport, earning these special cryogenic tanker ships the name “LNG carrier”. Liquefied natural gas (LNG) is produced in liquefaction plants by cooling natural gas below its boiling point (about −160 degrees Celsius at atmospheric pressure, depending on cargo grade). The LNG may be stored in cryogenic containers onboard the LNG carrier either at or slightly above atmospheric pressure. In most instances, LNG transported by LNG carrier is transported in liquefied form to a land-based delivery point, where a land-based regasification system converts the LNG back into natural gas.

Some LNG carriers are equipped with shipboard regasification facilities capable of converting the LNG back into a gaseous state. These “regasification” facilities vaporize the gas by adding heat to raise the temperature of LNG to at least its boiling point. LNG carriers equipped with onboard regasification facilities are called Regasification Vessels, Floating Storage Regasification Units (FSRU), or where there are no LNG cargo tanks in the hull, Floating Regasification Units (FRU). In order to deliver regasified natural gas, the regasification vessels dock at a special buoy connected to an underwater pipeline, which in turn connects to an onshore gas distribution system. In some instances, the regasification vessels moor at a dock, and deliver regasified natural gas to a gas pipeline that extends along the dock and connects to a gas distribution system. Current FSRUs range from 138,000 m³-266,000 m³ of LNG capacity sending gas to downstream customers such as power utilities or smelters.

Generally, regasification vessels suffer from two primary heat recovery problems. First, a heat source is needed to vaporize the LNG back to regasified natural gas. Conventionally, sea water is used as a heat source by placing the sea water in heat exchange with the LNG. However, use of sea water as a heat source suffers from several drawbacks. For example, the temperature of the sea water itself varies—depending on the geographic location of the vessel and the time of year—and colder sea water (temperatures below 28° C.) may not provide sufficient heat of vaporization and therefore requires supplementation with a secondary heat source. In addition, use of sea water for heat onboard the vessel reduces the temperature of the ambient sea water, which can be detrimental to sea life. Further, sea water is highly corrosive, and therefore flowing the water through pipes and other equipment onboard the vessel erodes the equipment or requires costly corrosion-inhibiting materials.

Second, equipment onboard the regasification vessel, such as the engines, air conditioning units and ship's machinery systems generate heat and therefore require cooling. Conventionally, sea water is also used to cool shipboard machinery onboard the regasification vessel. Unfortunately, this may detrimentally raise the temperature of the sea water surrounding the vessel also jeopardizing sea life, while additionally suffering from similar corrosion problems for shipboard systems. The inherent variability in sea water temperatures is a further source of inefficiency.

To date, attempts have been made to transfer heat from shipboard machinery to the LNG vaporizers and simultaneously and inversely employing the cold of the LNG to cooling ship machinery. However, in practice this idea has proven difficult to implement. Typically, the FSRU's vaporizers that require heat are located at the forward end of the vessel, and engine machinery that needs to be cooled is located at the aft of the vessel. Transporting fluids across the deck of the vessel requires pipelines that extend across the deck, which may suffer from heat loss in transport through the pipeline. Furthermore, the FSRU's vaporizers do not always operate continuously, and therefore heat and cooling requirements are not consistent throughout the vessel's operations. For example, heat of vaporization is not needed when the ship is not delivering (“sending out”) regasified natural gas, and therefore the cold of LNG is not available to cool equipment when there is no sendout. Furthermore, cooling needs of ship machinery may vary depending on whether the vessel is stationary or in motion, ambient temperatures, or whether the air conditioning unit is in operation.

As is apparent from the abovementioned problems, current heat recovery systems onboard FSRUs are limited in their ability to provide consistent and efficient cooling of shipboard equipment and heat for regasification. Therefore, there is a need for an improved apparatus, system and method for heat and cold recovery onboard an FSRU.

### BRIEF SUMMARY OF THE INVENTION

One or more embodiments of the invention enable an apparatus, system and method for heat and cold recovery onboard a floating storage regasification unit (FSRU).

An apparatus, system and method for heat and cold recovery onboard a FSRU is described. An illustrative embodiment of a heat recovery apparatus onboard a floating storage regasification unit (FSRU) includes a LNG vaporizer, a heat transfer fluid configured to transfer heat of vaporization to LNG in the LNG vaporizer during active regasification mode and thereby obtains cold of LNG, a heat recovery fluid comprising a portion of the heat transfer fluid, wherein the heat recovery fluid is configured to employ the cold of LNG to completely cool FSRU machinery and an FSRU air conditioning unit during active regasification mode, and thereby the heat recovery fluid obtains machinery heat, and wherein the heat of vaporization comprises the machinery heat and at least one additional heat source. In some embodiments, the FSRU machinery includes engine room machinery, main cooling, cargo machinery cooling, and forward area cooling. In certain embodiments, the heat recovery apparatus further includes a chilled water plant configured to cool the FSRU air conditioning unit and a sea water cooling system configured to cool the FSRU machinery, wherein during the active regasification mode the chilled water plant is off and the sea water cooling system is off. In some embodiments, the at least one additional heat source comprises sea water. In certain embodiments, the at least one additional heat source further comprises a sea chest, a strainer, a sea water pump and an overboard discharge. In some embodiments, the heat recovery apparatus further includes a first heat exchanger configured to transfer a first portion of the cold of LNG from the heat recovery fluid to a first fluid for cooling the FSRU air conditioning unit, and a second heat exchanger configured to transfer a second portion of the cold of LNG from the heat recovery fluid to a second fluid for cooling the FSRU machinery. In certain embodiments, the first heat exchanger and the second heat exchanger transfer machinery heat to the heat recovery fluid during the regasification mode. In some embodiments, the first fluid is chilled water and the second fluid is fresh water. In certain embodiments, the heat recovery apparatus further includes a chilled water plant, wherein the first fluid is configured to be cooled by the chilled water plant when the FSRU is in idle mode. In some embodiments, the heat recovery apparatus further includes a third heat exchanger configured to employ sea water to cool the second fluid when the FSRU is in idle mode. In certain embodiments, the heat recovery apparatus further includes a set of pipes extending on a deck of the FSRU, the set of pipes configured to transport the heat recovery fluid between the heat transfer fluid on a forward end of the deck, and the first heat exchanger and the second heat exchanger on an aft of the deck. In some embodiments, the heat recovery apparatus further includes a set of pipes extending one of externally along or internally through a hull of the FSRU, the set of pipes configured to transport the heat recovery fluid between the heat transfer fluid on a forward end of the deck, and the first heat exchanger and the second heat exchanger on an aft end of the deck. In certain embodiments, the regasification mode requires a minimum sendout of regasified natural gas. In some embodiments, the heat transfer fluid and the heat recovery fluid comprise glycol water.

An illustrative embodiment of a heat recovery method for a floating storage regasification unit (FSRU) includes collecting cold of LNG from a LNG vaporizer onboard a FSRU using a heat transfer fluid, diverting a portion of the heat transfer fluid containing the cold of LNG as a heat recovery fluid, transferring the cold of LNG from the heat recovery fluid to provide complete machinery systems cooling requirements onboard the FSRU, transferring machinery heat to the heat recovery fluid, and returning the machinery heat to the LNG vaporizer using the heat recovery fluid. In some embodiments, the complete machinery systems cooling requirements comprise air conditioning unit cooling requirements. In certain embodiments, the machinery heat and an additional heat source provide heat of vaporization of the LNG using the heat transfer fluid. In some embodiments, the heat recovery method further includes sending the heat recovery fluid between a forward end of a deck of the FSRU and an aft end of the deck of the FSRU through a pipeline extending across the deck. In certain embodiments, the heat recovery method further includes sending the heat recovery fluid between a forward end of a deck of the FSRU and an aft end of the deck of the FSRU through a pipeline extending through a hull of the FSRU.

An illustrative embodiment of a heat recovery method onboard a floating storage regasification unit (FSRU) includes employing cold capacity of LNG to meet total FSRU machinery cooling requirements and additionally provide cooling to an air conditioning unit onboard the FSRU by circulating a heat recovery fluid from a regasification system onboard the FSRU to a heat recovery system, wherein the heat recovery system is configured to replace all other cooling systems onboard the FSRU when the FSRU is in active regasification mode.

In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings in which:

FIG. 1 is an elevation view of a floating storage regasification unit (FSRU) of illustrative embodiments with exemplary heat recovery system piping extending across a deck of the FSRU.

FIG. 2 is an elevation view of a FSRU of illustrative embodiments with exemplary heat recovery system piping extending internally through the hull of the FSRU.

FIG. 3 is an elevation view of a FSRU of illustrative embodiments with exemplary heat recovery system piping extending externally along the hull of the FSRU.

FIG. 4A is a schematic diagram of a heat recovery system of illustrative embodiments onboard an FSRU with the exemplary heat recovery system turned on.

FIG. 4B is a schematic diagram of a heat recovery system of illustrative embodiments onboard an FSRU with the exemplary heat recovery system turned off.

FIG. 5 is a schematic diagram of a heat recovery method of illustrative embodiments.

While the invention is susceptible to various modifications and alternative forms, specific embodiments thereof are shown by way of example in the drawings and may herein be described in detail. The drawings may not be to scale. It should be understood, however, that the embodiments described herein and shown in the drawings are not intended to limit the invention to the particular form disclosed, but on the contrary, the intention is to cover all modifications, equivalents and alternatives falling within the scope of the present invention as defined by the appended claims.

### DETAILED DESCRIPTION

An apparatus, system and method for heat and cold recovery onboard a floating storage regasification unit (FSRU) will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

Any information in any material (e.g., a United States patent, a United States patent application, a book, an article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

As used in this specification and the appended claims, the singular forms “a”, “an” and “the” include plural referents unless the context clearly dictates otherwise. Thus, for example, reference to a heat exchanger includes one or more heat exchangers.

“Coupled” refers to either a direct connection or an indirect connection (e.g., at least one intervening connection) between one or more objects or components. The phrase “directly attached” means a direct connection between objects or components.

As used in this specification and the appended claims “high pressure” with respect to gaseous natural gas or LNG, means a pressure of at least 41×105 Pa (40 barg). With respect to pipelines and arms, “high pressure” means accommodating and transmitting gaseous natural gas or LNG, as the case may be, at a pressure of at least 41×105 Pa (40 barg).

As used in this specification and the appended claims, “FSRU” is used liberally to refer to any marine vessel configured to vaporize LNG and sendout regasified natural gas, such as without limitation a regasification vessel, a floating storage regasification unit and/or a floating regasification unit (FRU).

As used in this specification and the appended claims “direct heat exchange” means heat exchange without the use of an intermediary heat exchange fluid. For example, steam flowing through the inside of finned tubes whilst cool air flows around the outside of the finned tubes is one non-limiting example of direct heat exchange between the steam and the cool air. Where a heat exchange fluid, such as without limitation a glycol water mixture or fresh water, is used as an intermediary to transfer heat and/or cold between two other elements, such as to transfer heat between sea water and LNG by transferring heat from the sea water first to the intermediary heat exchange fluid and then from the intermediary heat exchange fluid to the LNG, such is referred to herein as “indirect” heat exchange.

As used in this specification and the appended claims “glycol water” refers to any intermediate heat exchange fluid that may be used for heat transfer in the regasification process, including, but not limited to any glycol/water mixtures and fresh water.

As used in this specification and the appended claims, “vaporizer” means vaporizers and/or heaters, unless the context clearly dictates otherwise.

Heat exchangers disclosed herein may for example be shell and tube heat exchangers, plate fin heat exchangers, finned tube heat exchangers, plate heat exchangers, or another similar type of heat exchanger well known to those of skill in the art. Specified types of heat exchangers are exemplary and may be substituted for another type of heat exchanger as appropriate to one of ordinary skill in the art. Pumps disclosed herein may for example be one or more of fluid transfer pumps, positive displacement pumps, axial flow pumps and/or single stage or multi-stage centrifugal pumps or another similar type of fluid-moving pump.

Illustrative embodiments may provide energy efficiency onboard a FSRU through a heat recovery system (HRS). The heat recovery system of illustrative embodiments may employ a heat recovery fluid to remove heat from engine room machinery and cool an air conditioning unit onboard the vessel. The HRS may employ the heat removed from the FSRU machinery systems and air conditioning unit in the LNG vaporizers. Simultaneously, cold capacity of LNG may be used to indirectly cool the shipboard machinery, and may additionally provide cooling to the ship's air-conditioning unit. Energy may be saved, equipment operating envelope improved, and corrosion of shipboard systems may be minimized, because a separate sea water cooling system for the FSRU machinery systems and/or a refrigerant system for the air conditioning unit may be turned off during regasification mode. When the regasification system is idle or below a minimum sendout, the refrigerant system and sea water cooling system may be used to cool the air conditioning unit and the engine room machinery respectively, although illustrative embodiments may minimize their usage. During active regasification mode, cold energy from the forward end of the vessel (bow) may be brought to the aft end to cool machinery, and heat may be brought from the rear (aft) end forward towards the bow to regasify the LNG. The heat recovery system of illustrative embodiments may serve the twin purposes of providing cooling to the vessel while also applying waste heat from shipboard systems to increase the efficiency of the regasification system onboard the FSRU.

The heat recovery system of illustrative embodiments may be capable of cooling the ship's machinery systems including engine room machinery, main cooling, cargo machinery cooling, and forward area cooling (small secondary system forward), as well as the air conditioning systems. The machinery's fresh-water cooling circuits may be cooled from a set of heat recovery heat exchangers that run parallel to the sea water cooling heat exchangers for each cooling circuit. The ship's air conditioning system may be cooled with a set of heat recovery heat exchangers parallel to the air conditioning system's chiller plants.

FSRU

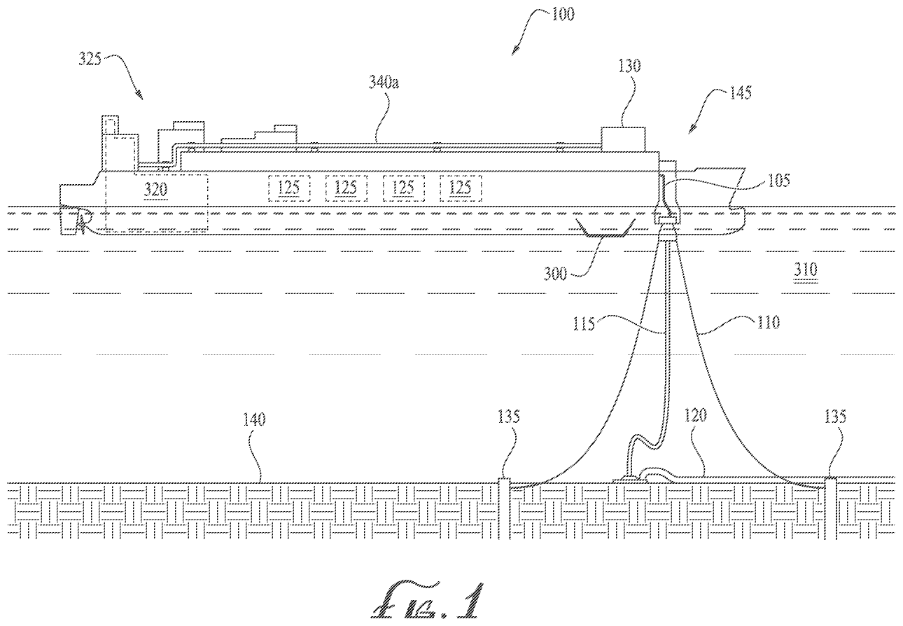

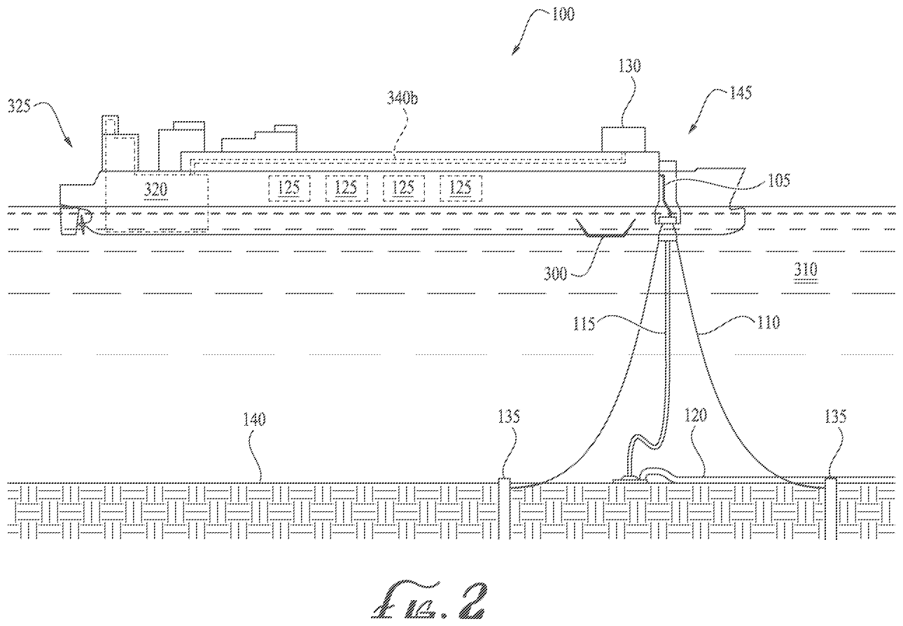

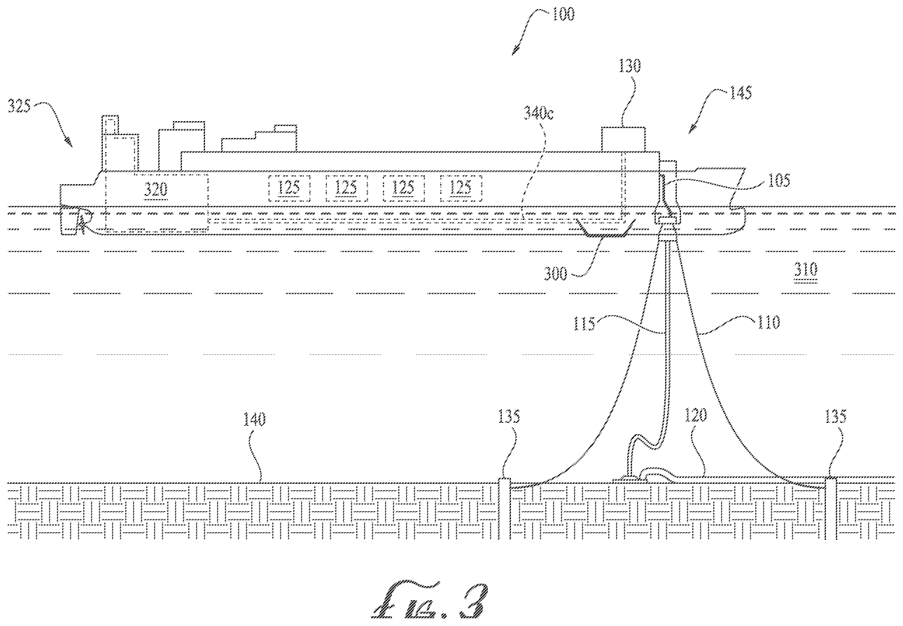

FIG. 1, FIG. 2 and FIG. 3 illustrate an FSRU of illustrative embodiments when the FSRU may be in regassification mode. FSRU 100 may be berthed, docked and/or moored at buoy 105 in a navigable body of water such as an ocean, lake or river. Buoy 105 may be a subsea turret buoy (sometimes referred to as a submerged turret loading or “STL” buoy), as shown in FIGS. 1-3, or an external turret buoy (not shown). In some embodiments, FSRU 100 maybe moored at a dock or jetty, rather than at buoy 105. One or more anchor lines 110 may secure buoy 105 to seabed 140 with anchors 135. Riser 115, which may be a submerged flexible riser, steel catenary riser, steel export riser and/or umbilical may extend from buoy 105 to seabed 140, and may fluidly connect buoy 105 to subsea natural gas pipeline 120, either through a subsea ring main or via subsea flow/pressure control manifold 160. FSRU 100 may berth to buoy 105 at and/or proximate to the forward end and/or bow 145 of FSRU 100. In some embodiments, FSRU 100 may be moored at an offshore platform, a dock or a sea island, rather than buoy 105. In such instances a high-pressure gas arm may transfer natural gas from FSRU 100 to pipeline 120 on the offshore platform, the dock or the sea island, and natural gas pipeline 120 may extend along the offshore platform, the dock or the sea island.

FSRU 100 may be a mobile floating storage regasification unit, a regasification vessel, a floating regasification unit (FRU) and/or another floating vessel or platform with LNG regasification facilities onboard, and the ability to both receive LNG cargo as a liquid and discharge such cargo as a gas. LNG cargos onboard FSRU 100 may be replenished using ship-to-ship transfer from an LNG carrier (LNGC), for example. Suitable LNG ship-to-ship transfer equipment may be as described in WO 2010/120908 to Bryngelson et al., which is commonly owned and incorporated herein by this reference in its entirety; provided however that in the event of any conflict, the present disclosure shall prevail. FSRU 100 may remain moored at buoy 105 for several days, several weeks or several years. FSRU 100 may store LNG cargo in cryogenic cargo tanks 125 in the hull of FSRU 100. Cryogenic LNG cargo tanks 125 may be membrane, self-supporting, prismatic, self-supporting spherical type cargo tanks or another similar type of cargo tank well known to those of skill in the art. FSRU 100 may include a steam turbine as the main propulsion engine, may include a dual-fuel diesel engine or another similar marine propulsion system.

Regasification System

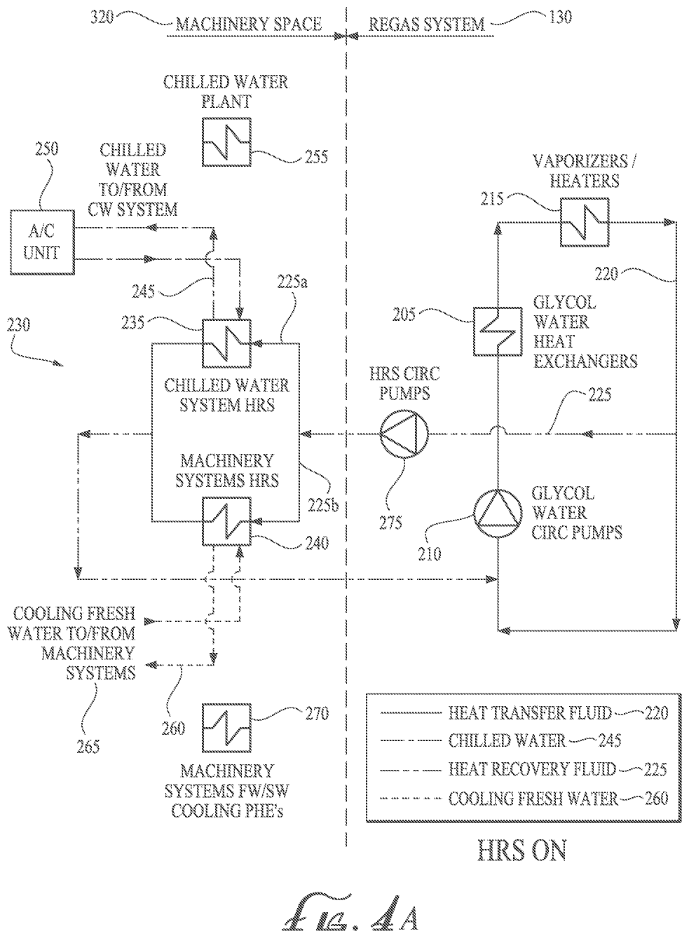

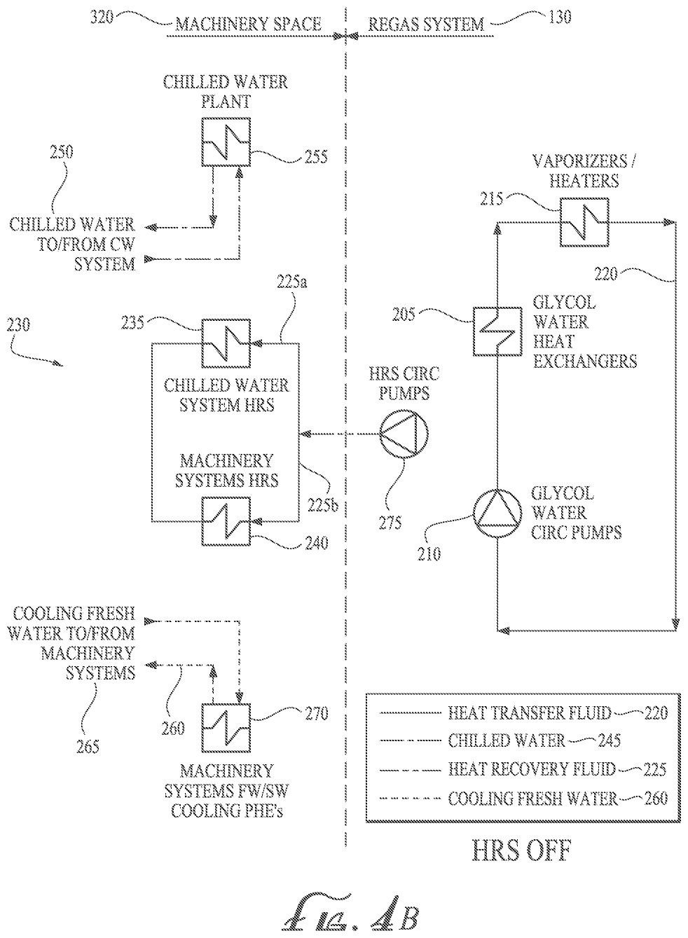

Regasification system 130 onboard FSRU 100 may receive LNG from cargo tanks 125 and convert the LNG to gaseous natural gas by adding heat to the LNG. Turning to FIG. 4A, regasification system 130 may use sea water 310 to provide heat to heat transfer fluid 220 through glycol water heat exchangers 205. Heat transfer fluid 220 may be circulated by glycol water circulation pumps 210 to vaporizers 215 to provide heat obtained from sea water 310 to vaporizer 215, heat which vaporizer 215 may then use to regasify the LNG. Heat transfer fluid 220 may be glycol mixed with water, fresh water and/or another intermediary heat transfer fluid. Glycol water circulation pumps 210 may be used to pump the glycol water through the glycol water heat exchangers 205 and vaporizers 215.

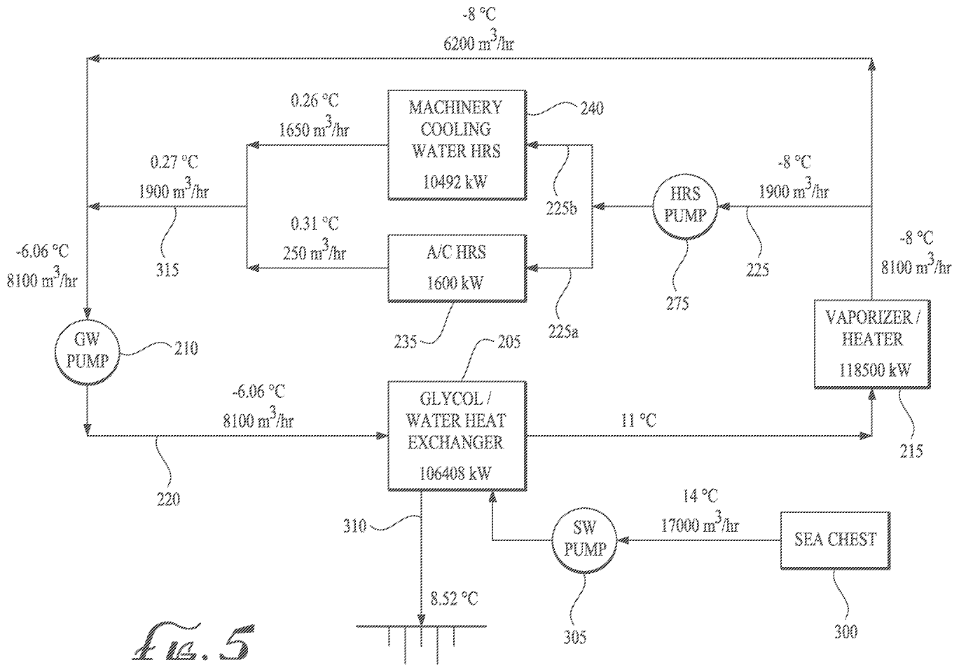

Heat transfer fluid 220 may flow in a loop from glycol water heat exchangers 205 to vaporizers 215, and then from vaporizers 215 back to glycol water heat exchangers 205, and so on. The sea water heating system may include sea chests 300, strainers, sea water pumps 305 and overboard discharges. As more specifically shown in FIG. 5, sea water 310 may be collected in sea chest 300 of FSRU 100 and pumped by sea water pump 305 through glycol water heat exchanger 205. In glycol water heat exchanger 205, the sea water's higher temperature (as compared to LNG) may be used to provide heat to heat transfer fluid 220.

FIGS. 4A and 4B illustrate regasification system 130 of illustrative embodiments. Vaporizer 215 of regasification system 130 may for example include four to six shell and tube vaporizers that may transfer heat from heat transfer fluid 220 to high pressure LNG. Sea water 310 surrounding FSRU 100 may be used as a heat source to vaporize LNG. Sea water 310 may flow through sea chest 300 of FSRU 100 to provide heat to heat transfer fluid 220 and then discharge sea water 310 overboard at a lower temperature in an open loop. Sea water 310 may provide heat to heat transfer fluid 220, which heat transfer fluid 220 may in turn flow through vaporizer 215 in heat exchange with LNG. Other heat sources are also contemplated for the vaporization of LNG, such as steam, or ambient air through the use of air heat exchangers, which alternative or additional heat sources may transfer heat to heat transfer fluid 220, and heat transfer fluid 220 may in turn transfer heat to LNG to vaporize the LNG into regasified natural gas. In the regasification mode of illustrative embodiments shown in FIG. 4A, the cold of LNG obtained by heat transfer fluid 220 in the LNG vaporizer 215 may be used to indirectly cool other equipment onboard FSRU 100. Natural gas discharged from FSRU 100 may be discharged through buoy 105 to natural gas pipeline 120 and/or a natural gas pipeline on a dock, platform or sea island.

Regasification system 130 may include vaporizers 215, glycol water heat exchangers 205 and one or more glycol water circulation pumps 210. Glycol water circulation pumps 210 may be fluid transfer pumps, positive displacement pumps, axial flow pumps and/or single stage or multi-stage centrifugal pumps. In one nonlimiting example, four to six vaporizers 215 and four to six glycol water heat exchangers 205 may be employed. Glycol water heat exchangers 205 may for example be shell and tube heat exchangers, plate fin heat exchangers, finned tube heat exchangers, plate heat exchangers, or another similar type of heat exchanger and may obtain heat from sea water 310, and transfer the heat of sea water 310 to heat transfer fluid 220.

Heat Recovery System (HRS)

The heat recovery system (HRS) 230 of illustrative embodiments may divert part of the cold-water (glycol water) flow out of vaporizer 215 using the HRS circulation pumps 275. This flow may be piped to the machinery spaces 320 (such as the chilled water system HRS heat exchanger 235 and/or the machinery systems HRS heat exchanger 240) to provide cooling and collect waste heat from the machinery systems, including the air conditioning system. Heat recovery system 230 of illustrative embodiments is shown in FIG. 4A. Regasification system 130 may be at, near and/or proximate to bow 145 of FSRU 100 and machinery space 320 may be at, proximate and/or near the aft 325 of FSRU 100.

During regasification mode (shown in FIG. 4A), heat recovery fluid 225, which may be a portion of heat transfer fluid 220, may be diverted to heat recovery system 230. During regasification mode, the portion of heat transfer fluid 220 that is not diverted as heat recovery fluid 225 may continue to circulate in regasification system 130 loop. HRS circulation pump 275 may circulate heat recovery fluid 225 through pipes 340 extending between the forward (bow 145) and aft 325 of FSRU 100. Pipes 340a may be insulated or non-insulated on the deck of FSRU 100, as shown in FIG. 1, pipes 340b may be insulated or non-insulated and extend internally through the hull of FSRU 100 as shown in FIG. 2, or pipes 340c may extend externally along, around and/or on the hull of FSRU 100 as shown in FIG. 3 and be insulated or non-insulated. Two pipes 340a, 340b and/or 340c may extend between machinery space 320 and regasification system 130 and/or between aft 325 and bow 145 of FSRU, with heat recovery fluid 225 flowing from bow 145 to aft 325 in a first pipe 340a, 340b, 340c and flowing in the opposite direction in a second pipe 340a, 340b, 340c to form a fluid loop between machinery space 320 and regasification system 130. In one nonlimiting illustrative example, pipes 340a, 340b, 340c may be 200 m long, 400 mm thick and 16-inch diameter. Size and number of HRS circulation pumps 275 may depend upon flowrates desired to accomplish shipboard machinery cooling. Upon reaching aft 325 of FSRU 100, heat recovery fluid 225 may flow through a chilled water system HRS heat exchanger 235 and a machinery system HRS heat exchanger 240. In some embodiments, Heat recovery fluid 225 may split with first branch 225a of the fluid flowing through chilled water system HRS heat exchanger 235 and second branch 225b of heat recovery fluid 225 flowing through machinery systems HRS heat exchanger 240. The first and second branch of heat recovery fluid 225 may recombine after exiting HRS heat exchangers 235 and 240, and then return to the glycol water loop of regasification system 130 circulating through vaporizers 215.

In chilled water system HRS heat exchanger 235, first branch 225a of heat recovery fluid 225 may provide cooling to chilled water (CW) 245 that in turn provides cooling to air conditioning unit 250. Chilled water system HRS heat exchanger 235 may replace the cooling provided by chilled water plant 255, and therefore may allow chilled water plant 255 to be turned off during regasification mode, as shown in FIG. 4A. First branch 225a may be around −8 degrees Celsius after exiting vaporizer 215 and therefore satisfy air conditioning unit 250 cooling requirement.

In machinery systems HRS heat exchanger 240, second branch 225b of heat recovery fluid 225 may provide cooling to cooling fresh water 260 that circulates and cools machinery 265 onboard FSRU 100. Cooling fresh water 260 may flow through pipes that extend around engine room and other shipboard machinery to accomplish cooling of such machinery 265. During regasification mode, machinery systems HRS heat exchanger 240 may entirely replace the fresh water/sea water cooling plate heat exchanger (PHE) 270 to provide cold to fresh water 260. When the regasification systems are off or below a minimum sendout, such as for example in some embodiments below a minimum sendout of 50 mmscfd, sea water 310 may provide cooling to fresh water 260 via PHE 270 as shown in FIG. 4B (idle mode).

Machinery Cooling

Regasification system 130 of illustrative embodiments may have the benefit of providing cooling to other machinery 265 systems on the FSRU. By using heat recovery fluid 225 employed in regasification system 130 to the cool ship's machinery 265, the quantity of sea water 310 required both to heat the LNG and to cool the ship's machinery 265 may be reduced. This use of heat recovery system (HRS) 230 may reduce the FSRU's electric load by operating fewer sea water pumps 305 for heating of heat transfer fluid 220, and thereby allow the crew to turn off all sea water cooling pumps (for the machinery systems fresh water (FW)/sea water (SW) Cooling PHE 270), reducing the system's running hours and maintenance required.

Illustrative embodiments of heat recovery system (HRS) 230 may provide total cooling to machinery 265 systems while the system is in regasification mode, including cooling the engine room machinery, main cooling, cargo machinery cooling, and forward area cooling (small secondary system forward). Heat recovery system 230 of illustrative embodiments may include redundant Plate Heat Exchangers (PHE's) 270, which may provide cooling to the machinery and heating to LNG vaporizers 215.

The cooling fresh water 260 to machinery 265 systems may be cooled using either of the following:
a set of FW/SW cooling PHE's 270—when HRS 230 is idle, i.e., when the ship is not in active regasification mode (shown in FIG. 4B); or
a set of machinery systems HRS heat exchangers 240, which may be plate heat exchangers 270—when HRS 230 is active, i.e., during normal regasification operations down to a minimum sendout (shown in FIG. 4A).

All machinery on board the vessel that is conventionally cooled by sea water 310 may be included in the HRS 230 setup.

When HRS 230 is active, the FW/SW cooling PHE's 270 and associated sea water cooling system may be shut down as shown in FIG. 4A. Therefore, illustrative embodiments may entirely eliminate sea water 310 as a cooling source onboard the vessel when the FSRU is in regasification mode.

Air Conditioning (A/C) System Cooling

To achieve the most efficient system, chilled water system 245 may be used for all air conditioning units 250 on the vessel, rather than a refrigerant cycle. Chilled water system 245 may be cooled by either HRS 230 or chilled water plants 255, as described herein. During normal regasification mode, HRS 230 may provide cooling to chilled water 245 using a set of chilled water system HRS heat exchangers 235. When the vessel is not in regasification, i.e., in transit or periods of no sendout, the vessel may use chilled water plant 255 for air conditioning unit 250 on the vessel. Chilled water plant 255, when in use, may be cooled as part of the machinery spaces 320 through the fresh water/sea water (FW/SW) cooling PHE's 270. Air conditioning unit 250 on FSRU 100 may be either a chilled water system or a direct expansion system. Regardless of the type of system used, air conditioning unit 250 may be included in HRS 230. HRS 230 may be optimized and arranged in series as a preferred configuration, or optionally as a parallel configuration, of the chilled water system HRS heat exchangers 235, which may be plate heat exchangers, and chilled water plant 255.

FSRU 100 may be equipped with an air conditioning unit 250 for accommodation based on chilled water 245 as a cooling medium and steam/hot water as a heating medium. A chilled water plant 255 with a redundancy system may be installed. All condensers on chilled water 245 system compressors may be fresh water cooled. The air handling unit for the air conditioning unit 250 may use chilled water 245 instead of refrigerant cycle. Individual Air Conditioning (A/C) Package Units may be replaced with fan coil units using chilled water 245.

Chilled water 245 may be supplied from either water-cooled chilled water plant(s) 255—for use during LNG carrier mode or when there is no or low send-out (i.e., during Minimum Sendout Compressor (MSOC) send-out, which may refer to when a high-pressure compressor exports natural boil-off gas when regasification system 130 is not online), herein referred to as idle mode as shown in FIG. 4B; or chilled water system HRS heat exchangers 235, obtaining heat from LNG regasification system 130 during normal regasification mode, as shown in FIG. 4A. HRS 230 of illustrative embodiments may be capable of providing all required cooling during all sendouts. In some embodiments, if there is insufficient cooling from heat recovery system 230 during regasification mode, chilled water plant 255 may be turned on to add capacity in addition to HRS 230.

While FSRU 100 is operating in areas of high sea water temperatures (above 28° C.), using HRS 230 may provide more effective cooling to engine room machinery 265 than the external sea water 310. Since most vessels are typically designed to operate with a maximum sea water 310 temperature of 32° C., conventionally operating above this temperature requires a de-rating of equipment with the subsequent lowering of capabilities and efficiencies. Since HRS 230 may allow the sea water cooling system (cooling plate heat exchanger 270) to machinery spaces 320 to be turned off, FSRU 100 of illustrative embodiments may advantageously operate while in temperatures greater than 35° C. with no de-rating of equipment.

FIG. 5 illustrates exemplary heat balance for heat recovery system 230 of illustrative embodiments. FIG. 5 provides an illustrative example of the heat balance and recovery of illustrative embodiments and shall be nonlimiting. Flows and temperatures may vary based on sendout rate, sea water temperature, and other similar considerations. For example, FIG. 5 contemplates a 750 mmscfd sendout, although 500 mmscfd, 250 mmscfd or 50 mmscfd may also be employed, as well as a range of other sendouts, provided the sendout is above 50 mmscfd or another minimum sendout. In this exemplary embodiment, heat transfer fluid 220 may enter vaporizers 215 at about 11 degrees Celsius. In this example, sea water 310 at 14 degrees Celsius, may flow from sea chest 300 at 17,000 m3/hr, moved by sea water pump 305 through glycol water heat exchanger 205. Sea water 310 may provide 106,408 KW of heat to heat transfer fluid 220 and exit glycol water heat exchanger 205 at about 8.52 degrees Celsius after heat exchange with heat transfer fluid 220 inside glycol water heat exchanger 205. After exiting glycol water heat exchangers 205, sea water 310 may be discharged back to the ocean and/or water surrounding FSRU 100.

Within vaporizer 215, heat transfer fluid 220 may be placed in heat exchange with LNG, raising the temperature of the LNG to vaporize the LNG and form regasified natural gas. 118,500 kW of heat may be transferred to LNG within vaporizer 215 in this example, and heat transfer fluid 220 may exit vaporizer 215 at 8,100 m3/hr at −8 degrees Celsius. Circulation pump 275 may divert portion 225a of heat recovery fluid 225 to heat recovery system 230 as a partial flow of 1,900 m3/hr and −8 degrees Celsius. First branch 225a may enter chilled water system HRS heat exchanger 235 and exit at 0.31 degrees Celsius and 250 m3/hr, while second branch 225b may enter machinery systems HRS heat exchanger 240 and exit at 0.26 degrees Celsius and 1,650 m3/hr. After exiting the HRS heat exchangers 235, 240, first branch 225a and second branch 225b of heat recovery fluid 225 may recombine to form a recombined fluid flow 315 of 1,900 m3/hr and 0.27 degrees Celsius. This recombined fluid flow 315 of heat recovery fluid 225 may then rejoin the regasification system 130 fluid loop to form heat transfer fluid 220 at −6.06 degrees Celsius and 8,100 m3/hr flow rate, which may then carry waste heat from ship machinery to vaporizer 215 and may be additionally heated in glycol water heat exchanger 205 back to 11 degrees Celsius before reentering vaporizer 215 whereby the cycle may be repeated.

Illustrative embodiments may advantageously employ waste heat from machinery spaces 320 as well as waste heat from air conditioning unit 250, onboard FSRU 100 in vaporizer 215. Simultaneously, cold of LNG may be employed to cool machinery 265 onboard FSRU 100 as well as provide cold to the vessel's air conditioning unit 250. The energy efficiency of illustrative embodiments may reduce power used for pumps and other equipment onboard the FSRU, and reduce the use of sea water 310 to both cool FSRU 100 machinery and also to heat LNG. During regasification mode, sea water cooling may be entirely eliminated. Reducing use of sea water 310 may reduce the corrosive effect of sea water 310 on vessel pipes and equipment and also reduce injury to sea life.

HRS system 230 may include a control panel, pumps and valves to allow an operator turn HRS system 230 on and/or off. In some embodiments, HRS system 230 may be programmed to automatically turn on when sendout of regasification system 130 is above a minimum sendout, such as when the sendout is 50 mmscfd or above. The control system for HRS system 230 may be integrated as part of the FSRU 100 control system. The control system may be set to open/close required valves and turn on/off pumps for either manual or automatic operation.

An apparatus, system and method for heat and cold recovery onboard an FSRU has been described. Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the scope and range of equivalents as described in the following claims. In addition, it is to be understood that features described herein independently may, in certain embodiments, be combined.

What is claimed is:

1. A heat recovery apparatus onboard a floating storage regasification unit (FSRU) comprising:
a LNG vaporizer;
a heat transfer fluid configured to transfer heat of vaporization to LNG in the LNG vaporizer during active regasification mode and thereby obtain cold of LNG;
a heat recovery fluid comprising a portion of the heat transfer fluid, wherein the heat recovery fluid is configured to employ the cold of LNG to completely cool FSRU machinery and an FSRU air conditioning unit during active regasification mode, and thereby the heat recovery fluid obtains machinery heat; and
wherein the heat of vaporization comprises the machinery heat and at least one additional heat source.

2. The heat recovery apparatus of claim 1, wherein the FSRU machinery comprises engine room machinery, main cooling, cargo machinery cooling, and forward area cooling.

3. The heat recovery apparatus of claim 1, further comprising a chilled water plant configured to cool the FSRU air conditioning unit and a sea water cooling system configured to cool the FSRU machinery, wherein during the active regasification mode the chilled water plant is off and the sea water cooling system is off.

4. The heat recovery apparatus of claim 1, wherein the at least one additional heat source comprises sea water.

5. The heat recovery apparatus of claim 4, wherein the at least one additional heat source further comprises a sea chest, a strainer, a sea water pump and an overboard discharge.

6. The heat recovery apparatus of claim 1, further comprising a first heat exchanger configured to transfer a first portion of the cold of LNG from the heat recovery fluid to a first fluid for cooling the FSRU air conditioning unit, and a second heat exchanger configured to transfer a second portion of the cold of LNG from the heat recovery fluid to a second fluid for cooling the FSRU machinery.

7. The heat recovery apparatus of claim 6, wherein the first heat exchanger and the second heat exchanger transfer machinery heat to the heat recovery fluid during the regasification mode.

8. The heat recovery apparatus of claim 6, wherein the first fluid is chilled water and the second fluid is fresh water.

9. The heat recovery apparatus of claim 6, further comprising a chilled water plant, wherein the first fluid is configured to be cooled by the chilled water plant when the FSRU is in idle mode.

10. The heat recovery apparatus of claim 6, further comprising a third heat exchanger configured to employ sea water to cool the second fluid when the FSRU is in idle mode.

11. The heat recovery apparatus of claim 6, further comprising a set of pipes extending on a deck of the FSRU, the set of pipes configured to transport the heat recovery fluid between:
the heat transfer fluid on a forward end of the deck; and
the first heat exchanger and the second heat exchanger on an aft of the deck.

12. The heat recovery apparatus of claim 6, further comprising a set of pipes extending one of externally along or internally through a hull of the FSRU, the set of pipes configured to transport the heat recovery fluid between:
the heat transfer fluid on a forward end of the deck; and
the first heat exchanger and the second heat exchanger on an aft end of the deck.

13. The heat recovery apparatus of claim 1, wherein the regasification mode requires a minimum sendout of regasified natural gas.

14. The heat recovery apparatus of claim 1, wherein the heat transfer fluid and the heat recovery fluid comprise glycol water.

15. A heat recovery method for a floating storage regasification unit (FSRU) comprising:
collecting cold of LNG from a LNG vaporizer onboard a FSRU using a heat transfer fluid;
diverting a portion of the heat transfer fluid containing the cold of LNG as a heat recovery fluid;
transferring the cold of LNG from the heat recovery fluid to provide complete machinery systems cooling requirements onboard the FSRU;
transferring machinery heat to the heat recovery fluid; and
returning the machinery heat to the LNG vaporizer using the heat recovery fluid.

16. The method of claim 15, wherein the complete machinery systems cooling requirements comprise air conditioning unit cooling requirements.

17. The method of claim 15, wherein the machinery heat and an additional heat source provide heat of vaporization of the LNG using the heat transfer fluid.

18. The method of claim 15, further comprising sending the heat recovery fluid between a forward end of a deck of the FSRU and an aft end of the deck of the FSRU through a pipeline extending across the deck.

19. The method of claim 15, further comprising sending the heat recovery fluid between a forward end of a deck of the FSRU and an aft end of the deck of the FSRU through a pipeline extending through a hull of the FSRU.

20. A heat recovery method onboard a floating storage regasification unit (FSRU) comprising:
employing cold capacity of LNG to meet total FSRU machinery cooling requirements and additionally provide cooling to an air conditioning unit onboard the FSRU by circulating a heat recovery fluid from a regasification system onboard the FSRU to a heat recovery system, wherein the heat recovery system is configured to replace all other cooling systems onboard the FSRU when the FSRU is in active regasification mode.
